(19) United States
(12) Patent Application Publication
(10) Pub. No.: US 2026/0121878 A1
(43) Pub. Date: Apr. 30, 2026

(54) CONSENSUS METHOD AND APPARATUS FOR BLOCKCHAIN SYSTEM

(71) Applicant: HANGZHOU HIGH-TECH ZONE (BINJIANG) INSTITUTE OF BLOCKCHAIN AND DATA SECURITY, Hangzhou (CN)

(72) Inventors: Shuai ZHANG, Hangzhou (CN); Hao DUAN, Hangzhou (CN); Xiaojing LI, Hangzhou (CN); Chao YUAN, Hangzhou (CN); Yangping LIN, Hangzhou (CN); Fanshu TANG, Hangzhou (CN); Xiangjuan JIA, Hangzhou (CN)

(21) Appl. No.: 19/433,720

(22) Filed: Dec. 27, 2025

Related U.S. Application Data
(63) Continuation of application No. PCT/CN2024/139687, filed on Dec. 16, 2024.

(30) Foreign Application Priority Data
Jun. 27, 2024 (CN) 202410844017.9

(51) Int. Cl. H04L 9/00; H04L 9/32

(52) U.S. Cl. CPC H04L 9/50; H04L 9/3268

(57) ABSTRACT

The present disclosure provides a consensus method and a consensus apparatus for a blockchain system. The consensus method includes: generating a subsequent proposal block by referencing a plurality of proposal blocks and combining current transactions from clients in an (n+x₂)-th consensus round; and achieving consensus on the preceding proposal block by using the subsequent proposal block as a certificate for the preceding proposal block. The plurality of proposal blocks are correspondingly generated by the plurality of validation nodes referencing a preceding proposal block in an n-th consensus round, and the preceding proposal block is generated in an (n−x₁)-th consensus round. In the consensus method of the present disclosure, there is no need to transmit a large amount of signature messages in the consensus process, and consensus on a specific block is achieved by establishing reference relationships between blocks generated in different consensus rounds.

### CROSS-REFERENCE TO RELATED APPLICATION

This application is a continuation of international patent application No. PCT/CN2024/139687, filed on Dec. 16, 2024, which itself claims priority to Chinese patent application No. 202410844017.9, filed on Jun. 27, 2024, and titled “CONSENSUS METHOD AND APPARATUS FOR BLOCKCHAIN SYSTEM”. The contents of the above identified applications are hereby incorporated herein in their entireties by reference.

### TECHNICAL FIELD

The present disclosure relates to the technical field of block chains, and in particular, to a consensus method and an apparatus for a blockchain system.

### BACKGROUND

In a blockchain, a consensus mechanism is used to ensure that all nodes in a network agree on a current state of the network and authenticity of a transaction, which is critical for maintaining security and integrity of the blockchain. A validation node participating in consensus needs to validate blocks and perform signature voting on the blocks. According to a principle of byzantine fault tolerance, blocks with a quorum of 2f+1 signature votes can pass validation, and can be correctly submitted and recorded in the blockchain. The quorum of 2f+1 signatures is proportional to the total quantity of 3f+1 validation nodes in a system. When the number of validation nodes in the system increases drastically, the number of signatures required for each block also increases drastically. At this point, the overhead of transmitting and validating signature messages becomes extremely high and difficult to control. Therefore, how to reduce cost of transmitting and validating signature messages in the consensus process has become a technical problem that urgently needs to be solved.

### SUMMARY

### Technical Problem

A consensus method and apparatus for a blockchain system are provided in embodiments of the present disclosure, which can solve the problem of high cost of transmitting and validating signature messages in the consensus process.

### Technical Solution

In a first aspect, a consensus method for a blockchain system is provided in an embodiment of the present disclosure. The blockchain system includes a plurality of validation nodes. The consensus method is performed by a validation node, and the consensus method includes:
generating a subsequent proposal block by referencing a plurality of proposal blocks and combining current transactions from clients in an (n+x₂)-th consensus round, in which the plurality of proposal blocks are correspondingly generated by the plurality of validation nodes referencing a preceding proposal block in an n-th consensus round, and the preceding proposal block is generated in an (n−x₁)-th consensus round; and
achieving consensus on the preceding proposal block by using the subsequent proposal block as a certificate for the preceding proposal block.

In a possible implementation, x₁ and x₂ are identical or different, and x₁ and x₂ are each equal to 1 or each not equal to 1.

In a possible implementation, the corresponding generation of the plurality of proposal blocks by the plurality of validation nodes referencing the preceding proposal block includes:
correspondingly generating the plurality of proposal blocks by the validation node, together with others of the plurality of validation nodes, referencing the preceding proposal block.

In a possible implementation, a step of referencing any proposal block includes: referencing a hash index of the any proposal block. The any proposal block is one of the plurality of proposal blocks or the preceding proposal block.

In a possible implementation, the preceding proposal block is generated by the validation node, or the preceding proposal block is generated by other validation nodes.

In a possible implementation, using the subsequent proposal block as the certificate for the preceding proposal block includes:
using the subsequent proposal block together with subsequent proposal blocks generated by at least one other validation node independently as certificates for the preceding proposal block, in which when the quantity of the certificates is greater than a preset threshold, the preceding proposal block is validated.

In a possible implementation, the quantity of the plurality of proposal blocks is not less than 2f+1, f is the quantity of dishonest validation nodes in the n-th consensus round, and 3f+1 is the total quantity of validation nodes in the n-th consensus round.

In a second aspect, a consensus apparatus for a blockchain system is provided in an embodiment of the present disclosure, including a subsequent proposal block generating module and a consensus module.

The subsequent proposal block generating module is configured to generate a subsequent proposal block by referencing a plurality of proposal blocks and combining current transactions from clients in an (n+x₂)-th consensus round. The plurality of proposal blocks are correspondingly generated by the plurality of validation nodes referencing a preceding proposal block in an n-th consensus round, and the preceding proposal block is generated in an (n−x₁)-th consensus round.

The consensus module is configured to achieve consensus on the preceding proposal block by using the subsequent proposal block as a certificate for the preceding proposal block.

In a possible implementation, x₁ and x₂ are identical or different, and x₁ and x₂ are each equal to 1 or each not equal to 1.

In a possible implementation, the validation node is configured to correspondingly generate the plurality of proposal blocks by referring to the preceding proposal block together with other validation nodes.

In a possible implementation, the subsequent proposal block generating module is specifically configured to reference a hash index of any proposal block. The any proposal block is one of the plurality of proposal blocks or the preceding proposal block.

In a possible implementation, the preceding proposal block is generated by the validation node, or the preceding proposal block is generated by other validation nodes.

In a possible implementation, the consensus module is specifically configured to use the subsequent proposal block together with subsequent proposal blocks generated by at least one other validation node independently as certificates for the preceding proposal block. When the quantity of the certificates is greater than a preset threshold, the preceding proposal block is validated.

In a possible implementation, the quantity of the plurality of proposal blocks is not less than 2f+1, f is the quantity of dishonest validation nodes in the n-th consensus round, and 3f+1 is the total quantity of validation nodes in the n-th consensus round.

In a third aspect, a terminal device is provided in an embodiment of the present disclosure, including a memory, a processor, and a computer program stored in the memory and executable on the processor. When executing the computer program, the processor implements the method described above.

In a fourth aspect, a computer-readable storage medium is provided in an embodiment of the present disclosure, on which a computer program is stored. The computer program is executed by a processor to implement the method described above.

### Beneficial Effects

A consensus method, a consensus apparatus, a terminal device, and a storage medium are provided in the present disclosure. Signature messages in conventional consensus methods are replaced by reference relationships, where a validation node referencing a certain proposal block indicates that the validation node has validated the proposal block. Therefore, the consensus method of the present disclosure eliminates the need to transmit a large amount of signature messages in the consensus process. Instead, consensus on a specific block is achieved by establishing reference relationships between blocks generated in different consensus rounds. In this way, the overhead of transmitting and validating signature messages in the consensus process is reduced.

### BRIEF DESCRIPTION OF THE DRAWINGS

To more clearly illustrate the technical solutions in the embodiments of the present disclosure, the accompanying drawings used in the embodiments or the description of the related art will be briefly introduced below. It is apparent that the drawings in the following description are only some embodiments of the present disclosure. For those skilled in the art, other drawings may also be derived from these drawings without creative efforts.

FIG. 1 is a schematic flowchart of a consensus method in an embodiment of the present disclosure.

FIG. 2 is a schematic diagram of a first embodiment of the present disclosure.

FIG. 3 is a schematic diagram of a second embodiment of the present disclosure.

FIG. 4 is a schematic diagram of a third embodiment of the present disclosure.

FIG. 5 is a schematic diagram of reference relationships in an embodiment of the present disclosure.

FIG. 6 is a schematic diagram of a fourth embodiment of the present disclosure.

FIG. 7 is a schematic diagram of a fifth embodiment of the present disclosure.

FIG. 8 is a schematic diagram of a sixth embodiment of the present disclosure.

FIG. 9 is a schematic diagram of a seventh embodiment of the present disclosure.

FIG. 10 is a schematic diagram of an eighth embodiment of the present disclosure.

FIG. 11 is a schematic diagram of a ninth embodiment of the present disclosure.

FIG. 12 is a schematic diagram of a tenth embodiment of the present disclosure.

FIG. 13 is a schematic diagram of an eleventh embodiment of the present disclosure.

FIG. 14 is a schematic structural diagram of a consensus apparatus in an embodiment of the present disclosure.

FIG. 15 is a schematic structural diagram of a terminal device in an embodiment of the present disclosure.

### DETAILED DESCRIPTION

In the following description, specific details such as specific system structures and technologies are set forth for illustrative purposes rather than limitation, so as to provide a thorough understanding of the embodiments of the present disclosure. However, it should be clear to those skilled in the art that the present disclosure may be implemented in other embodiments without these specific details. In other instances, detailed descriptions of well-known systems, apparatus, circuits, and methods are omitted to avoid unnecessary details from obscuring the description of the present disclosure.

It should be understood that when used in the specification and appended claims of the present disclosure, the term “comprise” or “include” indicates the presence of described features, integers, steps, operations, elements, and/or components, but does not exclude the presence or addition of one or more other features, integers, steps, operations, elements, components, and/or combinations thereof.

It should also be understood that the term “and/or” as used in the specification and the appended claims of the present disclosure refers to any combination of one or more of the associated listed items and all possible combinations, and includes such combinations.

As used in the specification and the appended claims of the present disclosure, the term “if” may be interpreted contextually as “when”, “once”, “in response to determining”, or “in response to detecting”. Similarly, the phrase “if it is determined” or “if [a described condition or event] is detected” may be interpreted contextually to mean “once it is determined”, “in response to determining”, “once [the described condition or event] is detected”, or “in response to detecting [the described condition or event]”.

In addition, in the explanation of the specification and the appended claims of the present disclosure, the terms “first”, “second”, “third”, and the like are merely used to distinguish explanations, and should not be construed as indicating or implying relative importance.

In the specification of the present disclosure, references to “one embodiment” or “some embodiments” and the like in the description of the present disclosure mean that specific features, structures, or characteristic described in connection with the embodiment are included in one or more embodiments of the present disclosure. Thus, appearance of the phrases “in one embodiment”, “in some embodiments”, “in some other embodiments”, “in yet other embodiments”, and the like in various places throughout this specification are not necessarily all referring to the same embodiment, but rather mean “one or more but not all embodiments”, unless otherwise specifically emphasized. The terms “include”, “comprise”, “having”, and variations thereof are mean “include but are not limited to”, unless otherwise specifically emphasized.

In a blockchain system, a consensus protocol must be employed to ensure consistency among distributed nodes in the system. Each validation node (also referred to as validator) in the consensus protocol is also referred to as a consensus node, and is required to validate blocks and perform signature voting on the blocks. According to a principle of byzantine fault tolerance, blocks with quorum of 2f+1 signature votes can pass validation, and can be correctly submitted and recorded in the blockchain. The quorum of 2f+1 signatures is proportional to the total quantity of 3f+1 validation nodes in the system. When the number of the validation nodes in the system increases, the number of signatures required for each block also increases drastically. At this point, the overhead of transmitting and validating signature messages becomes extremely high and difficult to control. Therefore, how to reduce cost of transmitting and validating of signature messages in the consensus process has become a technical problem that urgently needs to be solved.

A consensus method, a consensus apparatus, a terminal device, and a storage medium are provided in the present disclosure. Signature messages in conventional consensus methods are replaced by reference relationships, where a validation node referencing a certain proposal block indicates that the validation node has validated the proposal block. Therefore, in the consensus method of the present disclosure, the need to transmit a large amount of signature messages in the consensus process is eliminated, and it is determined whether a proposal block has been validated through a sufficient number of validation nodes by examining these reference relationships. In this way, the overhead of transmitting and validating signature messages in the consensus process is reduced.

Specific embodiments are provided below to illustrate the technical solutions of the present disclosure.

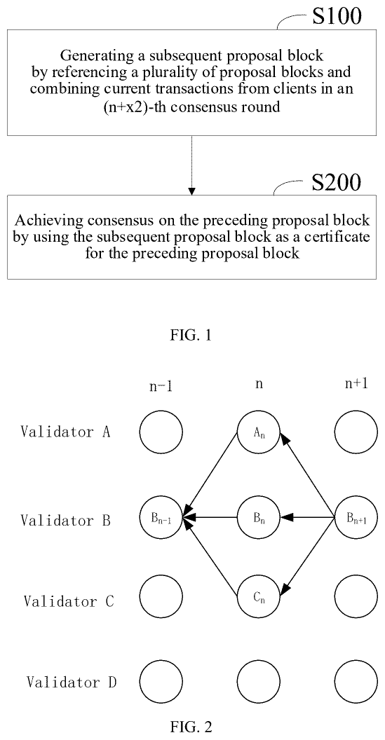

Referring to a flowchart of an embodiment of a consensus method for a blockchain system shown in FIG. 1, which is provided by way of example and is not limited thereto. The consensus method includes the following steps:
Step 100, generating a subsequent proposal block by referencing a plurality of proposal blocks and combining current transactions from clients in an (n+x₂)-th consensus round. The plurality of proposal blocks are correspondingly generated by the plurality of validation nodes referencing a preceding proposal block in an n-th consensus round, and the preceding proposal block is generated in an (n−x₁)-th consensus round.
Step 200, achieving consensus on the preceding proposal block by using the subsequent proposal block as a certificate for the preceding proposal block.

It should be noted that the blockchain system of the present disclosure includes a plurality of validation nodes, and the consensus method in the embodiments of the present disclosure is performed by a validation node. Validation nodes, which are specifically authenticated and authorized nodes in a blockchain network, have permission to participate in consensus processes, validate transactions, and package blocks. Specifically, tasks under the responsibility of the validation nodes include executing a consensus algorithm. As described in the above solution, the validation nodes reference proposal blocks in specific consensus rounds, generate the subsequent proposal block, and participate in consensus on the preceding proposal block. The validation nodes further validate transactions, to ensure legality, validity, and compliance with protocol rules of the blockchain for the transactions. In addition, based on results of the consensus algorithm, the validation nodes package legitimate transactions to generate new blocks and attempt to add the blocks to the blockchain.

It may be understood that a threshold is usually set in the blockchain system, and a specific quantity of validation nodes are required to validate a same proposal block, so that the proposal block can be added to the blockchain. This process ensures that most validation nodes in the network have reached consensus on new block content. In a conventional consensus process, if a validation node validates a proposal block, the proposal block needs to be signed and broadcast to other validation nodes in the system, and the other validation nodes need to validate the signature, resulting in the transmission and verification of a large amount of signature messages in the consensus process.

In the consensus method according to the present disclosure, when a validation node references a proposal block generated in a previous consensus round, it indicates that the validation node has validated the proposal block. That is, signature messages in conventional consensus methods are replaced by reference relationships in the present disclosure. Therefore, the transmission of the large amount of signature messages is no longer required in the consensus process. Instead, it is determined whether a proposal block is validated through a sufficient number of validation nodes by examining the reference relationships.

It should be noted that, in the present disclosure, the establishment of a reference relationship is based on successful validation. That is, a block needs first to be validated to ensure that the content of the proposal block complies with rules of the blockchain and security requirements of the network. When the validation is passed, a reference relationship with the block can be established.

Exemplarily, a validation node may validate the correctness of a proposal block by examining signature, block data content, block hash, and block timestamp of the proposal block. For example, the validation node may examine whether transaction data in the block is valid and legitimate, including examining whether a field of the transaction is complete, whether a format of the transaction complies with the protocol rules of the blockchain, and the like. For each transaction, the validation node may also need to examine whether input and output of the transaction are balanced. For another example, the validation node may further calculate a hash value of the proposal block, and compare the hash value with a hash value stored in a block header, to ensure that the block is not tampered with during transmission. Alternatively, the validation node may examine whether a timestamp in the proposal block is reasonable, and the timestamp is configured to record a time at which the block is created, and may help the validation node detect potential double-spending or duplicate transactions.

Therefore, it may also be understood that referencing a proposal block indicates approval of the proposal block. In a subsequent consensus process, it may be determined whether a proposal block is referenced by a sufficient number of validation nodes via examining reference relationships between proposal blocks. When the quantity of validation nodes referencing the proposal block meets certain requirements, it may be considered that the proposal block has obtained sufficient approval, meaning the proposal block is trustworthy.

In a conventional consensus method, each proposal block needs to carry at least 2f+1 signatures, and the quantity of signatures required by each block increases drastically when the quantity of validation nodes in the system increases drastically. In contrast, the consensus method provided in present disclosure uses reference relationships to indicate the approval of a certain proposal block, rather than relying on signatures to achieve consensus on the proposal block. Consequently, the transmission of a large amount of signature messages is no longer required in the consensus process. Thus, the overhead of transmitting and validating the signature messages in the consensus process is reduced.

It should be noted that at step 100, when generating the subsequent proposal block, the validation node may further need to integrate the current transactions from the clients. Transactions may refer to a series of operations or requests initiated by users (i.e., clients) on a blockchain network, which alter a state or data on the blockchain. These transactions may include invocation of smart contracts, writing or updating of data, and the like.

It should be noted that the implementation process of referencing the proposal blocks is based on a directed acyclic graph (DAG). This means the blockchain system is not only a simple linear structure, but uses a more complex graph structure to organize and reference the proposal blocks.

For better understanding of the present disclosure, a brief introduction to the DAG is provided first. The DAG is a graph that includes directional edges and no cycles. In a blockchain system. The DAG may be used to represent reference relationships between proposal blocks, and each proposal block may point to one or more preceding proposal blocks to form a complex network structure.

Specifically, the blockchain system may maintain a pre-stored DAG that records all proposal blocks and reference relationships among the proposal blocks. When a validation node intends to reference a preceding proposal block, the validation node may query the pre-stored DAG to find a suitable block to reference. The basis for referencing may include age of the block (i.e., generation time), the quantity of involved transactions, quality of the block, or other customized strategies.

When constructing a new proposal block, the validation node may select one or more preceding proposal blocks to reference based on current transaction data and reference relationships in the DAG. When a new proposal block is successfully added to the DAG and confirmed by other validation nodes in the network, the structure of the DAG may be updated accordingly to reflect the new reference relationships and addition of the block.

The consensus method that references proposal blocks via the DAG may enable the blockchain system to be more flexible and efficient when processing a large amount of transactions and rapidly generating blocks. The validation nodes may achieve consensus by processing multiple proposal blocks in parallel and finding suitable paths in the DAG, thereby enhancing throughput and performance of the entire system.

In a possible implementation, x₁ and x₂ may be identical or different, and x₁ and x₂ may be each equal to 1 or each not equal to 1.

It should be noted that x₁ may be 1 or a positive integer greater than 1. When x₁ is 1, it indicates that the round in which a proposal block is generated is consecutive to the round in which a preceding proposal block is generated. When x₁ is not 1, it indicates that the round in which a proposal block is generated is not consecutive to the round in which a preceding proposal block is generated. Similarly, x₂ may also be 1 or a positive integer greater than 1. When x₂ is equal to 1, it indicates that the round in which a proposal block is generated is consecutive to the round in which a subsequent proposal block is generated. When x₂ is not equal to 1, it indicates that the round in which a proposal block is generated is not consecutive to the round in which a subsequent proposal block is generated.

The above content will be explained below with specific embodiments.

A first embodiment: referring to FIG. 2, in the present embodiment, x₁=1 and x₂=1. That is, in an (n+1)-th consensus round, proposal blocks Aₙ, Bₙ, and Cₙ generated in an n-th consensus round may be referenced to generate a subsequent proposal block Bₙ₊₁. Each of the three proposal blocks Aₙ, Bₙ, and Cₙ may reference a preceding proposal block Bₙ₋₁ generated in an (n−1)-th consensus round. Therefore, the subsequent proposal block Bₙ₊₁ may be used as a certificate of the preceding proposal block Bₙ₋₁ for achieving consensus on the preceding proposal block Bₙ₋₁.

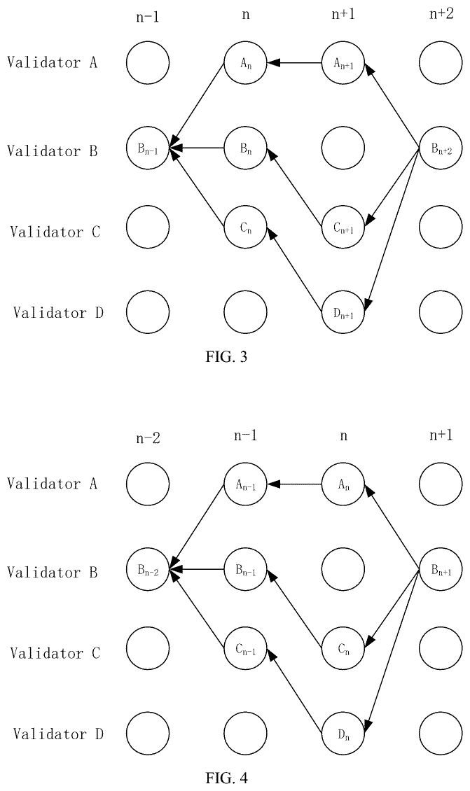

A second embodiment: referring to FIG. 3, in the present embodiment, x₁=1 and x₂≠1. Specifically, taking x₂ equal to 2 as an example, this means in an (n+2)-th consensus round, proposal blocks Aₙ, Bₙ, and Cₙ generated in an n-th consensus round may be referenced in an indirect referencing manner to generate a subsequent proposal block Bₙ₊₂. Each of the three proposal blocks Aₙ, Bₙ, and Cₙ may reference a preceding proposal block Bₙ₋₁ generated in an (n−1)-th consensus round. Therefore, the subsequent proposal block Bₙ₊₂ may be used as a certificate of the preceding proposal block Bₙ₋₁ for achieving consensus on the preceding proposal block Bₙ₋₁.

It should be noted that since blocks generated in the (n+1)-th consensus round have reference relationships with the proposal blocks generated in the n-th consensus round, the proposal blocks generated in the n-th consensus round may be referenced by the subsequent proposal block Bₙ₊₂ in an indirect referencing manner by referencing the blocks generated in the (n+1)-th consensus round.

Exemplarily, since a block Aₙ₊₁ has a reference relationship with a proposal block Aₙ, the proposal block Aₙ may be referenced by the subsequent proposal block Bₙ₊₂ by referencing the block Aₙ₊₁. Similarly, since a block Cₙ₊₁ has a reference relationship with a proposal block Bₙ, the proposal block Bₙ may be referenced by a subsequent proposal block Bₙ₊₂ by referencing the block Cₙ₊₁. Similarly, since a block Dₙ₊₁ has a reference relationship with a proposal block Cₙ, the proposal block Cₙ may be referenced by the subsequent proposal block Bₙ₊₂ by referencing the block Dₙ₊₁.

A third embodiment: referring to FIG. 4, in the present embodiment, x₁≠1 and x₂=1. Specifically, taking x₁ equal to 2 as an example, this means in an (n+1)-th consensus round, proposal blocks Aₙ, Bₙ, and Cₙ generated in an n-th consensus round may be referenced to generate a subsequent proposal block Bₙ₊₁. Each of the three proposal blocks Aₙ, Bₙ, and Cₙ may reference a preceding proposal block Bₙ₋₂ generated in an (n−2)-th consensus round in an indirect referencing manner. Therefore, the subsequent proposal block Bₙ₊₁ may be used as a certificate of the preceding proposal block Bₙ₋₂ for achieving consensus on the preceding proposal block Bₙ₋₂.

It should be noted that since blocks generated in the (n−1)-th consensus round have reference relationships with preceding proposal blocks generated in the (n−2)-th consensus round, the preceding proposal blocks generated in the (n−2)-th consensus round may be referenced in an indirect referencing manner by a proposal block by referencing the blocks generated in the (n−1)-th consensus round.

Exemplarily, since a block Aₙ₋₁ has a reference relationship with a proposal block Bₙ₋₂, a proposal block Aₙ may reference the preceding proposal block Bₙ₋₂ by referencing the block Aₙ₋₁. Similarly, since a block Bₙ₋₁ has a reference relationship with a preceding proposal block Bₙ₋₂, a proposal block Cn may reference the preceding proposal block Bₙ₋₂ by referencing the block Bₙ₋₁. Similarly, since a block Cₙ₋₁ has a reference relationship with a preceding proposal block Bₙ₋₂, a proposal block Dₙ may reference the preceding proposal block Bₙ₋₂ by referencing the block Cₙ₋₁.

It should be noted that, as demonstrated by the above embodiments, referencing may include direct referencing and indirect referencing. The direct referencing means referencing blocks generated in the immediately preceding round. Exemplarily, referring to FIG. 3, a block Aₙ references a block Bₙ₋₁, a block Bₙ₊₂ references a block Cₙ₊₁, or a block Aₙ₊₁ references a block Aₙ. The indirect referencing means referencing proposal blocks generated in a non-consecutive round. Exemplarily, referring to FIG. 3, a block Bₙ₊₂ references a block An, which is achieved by the block Bₙ₊₂ referencing a block Aₙ through a block Aₙ₊₁ in an indirect referencing manner.

In a possible implementation, the corresponding generation of the plurality of proposal blocks by the plurality of validation nodes referencing the preceding proposal block may include:
correspondingly generating the plurality of proposal blocks by the validation node, together with others of the plurality of validation nodes, referencing the preceding proposal block.

It should be noted that in the n-th consensus round, the process of referencing a preceding proposal block to generate a proposal block is involved. An entity executing this process may or may not include the validation node.

This will be explained by using the first embodiment and the third embodiment described above. Referring to the schematic diagram of the first embodiment shown in FIG. 2, the validation node represented as Validator B participates in the generation process of the proposal block in the n-th consensus round. That is, the Validator B references the preceding proposal block Bₙ₋₁ to generate the proposal block Bₙ in the n-th consensus round. However, in the third embodiment shown in FIG. 4, the validation node represented as Validator B does not participate in the generation process of the proposal block in the n-th consensus round. That is, the Validator B does not reference a preceding proposal block and fail to generate the proposal block Bₙ in the n-th consensus round.

Therefore, in embodiments of the present disclosure, the entity executing the process of referencing a preceding proposal block to generate a proposal block may include the validation node, or may not include the validation node.

In a possible implementation, a step of referencing any proposal block may include referencing a hash index of the any proposal block. The any proposal block may be one of the plurality of proposal blocks or the preceding proposal block.

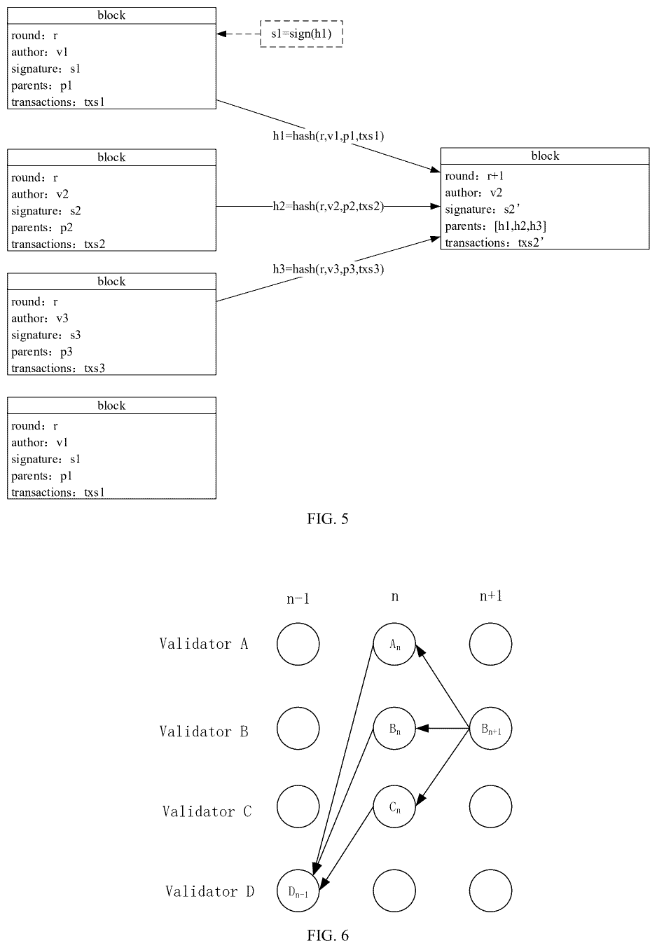

It should be noted that the proposal block may include a transaction list, a current consensus round, a proposal signer, a proposal signature, and reference relationships with proposal blocks generated in previous rounds. Referring to FIG. 5, each proposal block may include a transaction list (represented as transactions), a current consensus round (represented as round), a proposal signer (represented as author), a proposal signature (represented as signature), and reference relationships (represented as parents) to previous-round proposal blocks.

In a possible implementation, the hash index may be generated based on the current consensus round, the proposal signer, the transaction list, and the reference relationships. Referring to FIG. 5, in the illustrated case, hash indices may include h1, h2, and h3. Here, h1 is calculated by a hash function according to the current consensus round r, the proposal signer v1, the transaction list txs1, and the reference relationship p1; h2 is calculated by a hash function according to the current consensus round r, the proposal signer v2, the transaction list txs2, and the reference relationship p2; and h3 is calculated by a hash function according to the current consensus round r, the proposal signer v3, the transaction list txs3, and the reference relationship p3.

It should be noted that referencing is based on the proposal block having been validated. The validation may include validation of correspondence between the signer and the signature of the proposal block, as well as validation of correctness of the reference relationship.

Specifically, it is necessary to validate the correspondence between the signer and the signature of the proposal block. According to the present disclosure, consensus is achieved through a plurality of consensus rounds. Each honest validation node may sign unique proposal block thereof in each consensus round and then broadcast the signed proposal block to other validation nodes, to prove that the block is indeed generated by the honest validation node. The validation node may examine whether the signature matches the signer and whether the signature is valid (not tampered with or counterfeit), thus preventing malicious nodes from counterfeiting blocks or tampering with transactions.

In addition, it is necessary to validate the correctness of the reference relationship. Since each proposal block references several (not less than a quorum of) proposal blocks, a validation node needs to examine whether a hash value of a referenced proposal block is correct to ensure integrity and continuity of the blockchain.

Furthermore, when generating the subsequent proposal block, current transactions from clients may also need to be incorporated, and these transactions may need to be validated as well. Specifically, a transaction list of the current transactions may be validated, including validating validity of each transaction, identities of a sender and a receiver, whether a transaction amount is correct, and the like, to ensure that legitimate and valid transactions can be added to the blockchain.

In a possible implementation, the preceding proposal block may be generated by the validation node, or the preceding proposal block may be generated by other validation nodes.

It should be noted that, in the first embodiment, the second embodiment, and the third embodiment, each of the preceding proposal block and the subsequent proposal block may be generated by the same validator. However, in some possible implementations, corresponding to the above three cases, the preceding proposal block and the subsequent proposal block may also be generated by different validators. This will be explained below with specific embodiments.

A fourth embodiment: referring to FIG. 6, in the present embodiment, x₁=1, x₂=1, and the preceding proposal block and the subsequent proposal block are generated by different validation nodes.

It should be noted that the present embodiment differs from the first embodiment in that the preceding proposal block and the subsequent proposal block are generated by different validation nodes. In the first embodiment, each of the preceding proposal block Bₙ₋₁ and the subsequent proposal block Bₙ₊₁ may be generated by the validation node represented as Validator B. However, in the fourth embodiment, the preceding proposal block Dₙ₋₁ may be generated by the validation node represented as Validator D, and the subsequent proposal block Bₙ₊₁ may be generated by the validation node represented as Validator B.

Specifically, in an (n+1)-th consensus round, a subsequent proposal block Bn+1 may be generated by referencing proposal blocks Aₙ, Bₙ, and Cₙ generated in an n-th consensus round. Since each of the three proposal blocks Aₙ, Bₙ, and Cₙ references the preceding proposal block Dₙ₋₁ generated in the (n−1)-th consensus round, the subsequent proposal block Bₙ₊₁ may be used as a certificate of the preceding proposal block Dₙ₋₁ for achieving consensus on the preceding proposal block Dₙ₋₁.

A fifth embodiment: referring to FIG. 7, in the present embodiment, x₁=1, x₂≠1, and the preceding proposal block and the subsequent proposal block are generated by different validation nodes.

It should be noted that the present embodiment differs from the second embodiment in that the preceding proposal block and the subsequent proposal block are generated by different validation nodes. In the second embodiment, each of the preceding proposal block Bₙ₋₁ and the subsequent proposal block Bₙ₊₁ is generated by the validation node represented as Validator B. However, in the fifth embodiment, the preceding proposal block Cₙ₋₁ is generated by the validation node represented as Validator C, and the subsequent proposal block Bₙ₊₂ is generated by the validation node represented as Validator B.

Specifically, the subsequent proposal block Bₙ₊₂ may be generated in an (n+2)-th consensus round by referencing the proposal blocks Aₙ, Bₙ, and Cₙ generated in the n-th consensus round in an indirect referencing manner. Since each of the three proposal blocks Aₙ, Bₙ, and Cₙ references the preceding proposal block Cₙ₋₁ generated in the (n−1)-th consensus round, the subsequent proposal block Bₙ₊₂ may be used as a certificate of the preceding proposal block Cₙ₋₁ for achieving consensus on the preceding proposal block Cₙ₋₁.

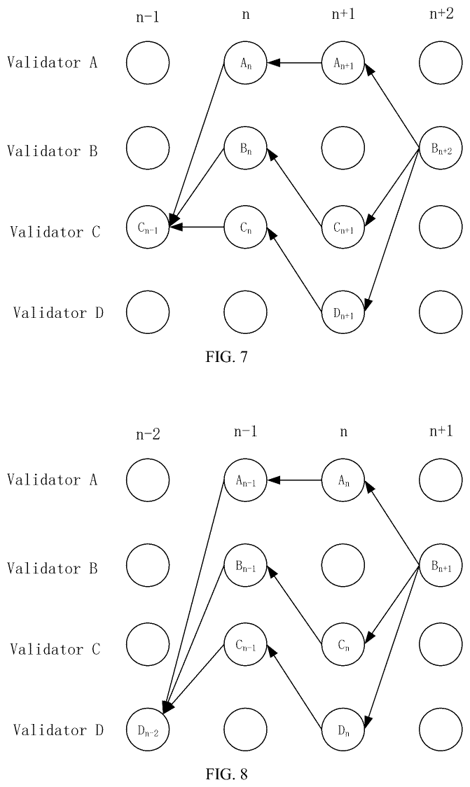

A sixth embodiment: referring to FIG. 8, in the present embodiment, x₁≠1, x₂=1, and the preceding proposal block and the subsequent proposal block are generated by different validation nodes.

It should be noted that the present embodiment differs from the third embodiment in that the preceding proposal block and the subsequent proposal block are generated by different validation nodes. In the third embodiment, each of the preceding proposal block Bₙ₋₂ and the subsequent proposal block Bₙ₊₁ is generated by the validation node represented as Validator B. However, in the sixth embodiment, the preceding proposal block Dₙ₋₂ is generated by the validation node represented as Validator D, and the subsequent proposal block Bₙ₊₁ is generated by the validation node represented as Validator B.

Specifically, the subsequent proposal block Bₙ₊₁ may be generated in an (n+1)-th consensus round by referencing the proposal blocks Aₙ, Bₙ, and Cₙ generated in the n-th consensus round. Since each of the three proposal blocks Aₙ, Bₙ, and Cₙ references the preceding proposal block Dₙ₋₂ generated in the (n−2)-th consensus round in an indirect referencing manner, the subsequent proposal block Bₙ₊₁ may be used as a certificate of the preceding proposal block Dₙ₋₂ for achieving consensus on the preceding proposal block Dₙ₋₂.

In a possible implementation, using the subsequent proposal block as the certificate for the preceding proposal block may include: using the subsequent proposal block together with subsequent proposal blocks generated by at least one other validation node independently as certificates for the preceding proposal block. When the quantity of the certificates is greater than a preset threshold, the preceding proposal block may be validated.

It should be noted that a certificate represents confirmation and acceptance of a to-be-submitted proposal block by a validation node. Each validation node may generate certificates for one or more to-be-submitted proposal blocks. These certificates accumulate to form a quantitative indicator of extent to which one proposal block is accepted. In order to ensure the stability and security of the blockchain, when the quantity of certificates for the proposal block to be submitted reaches or exceeds the preset threshold, the proposal block is considered to have sufficient support and thus submitted to the target blockchain.

It should be further noted that the preset threshold for the quantity of certificates may be adjusted according to a specific circumstance of the blockchain network. For example, when the blockchain network has a relatively small scale or the quantity of validation nodes is relatively small, the preset threshold for the quantity of certificates may be appropriately decreased. Conversely, when the blockchain network has a relatively large scale or the quantity of validation nodes is relatively large, the preset threshold for the quantity of certificates may be appropriately increased.

In the present embodiment of the present disclosure, for a same preceding proposal block, a plurality of subsequent proposal blocks may be used as certificates for the preceding proposal block. The plurality of certificates may be generated by different validation nodes in a same consensus round, or may be generated by a same validation node in different rounds. This will be explained below through specific embodiments.

A seventh embodiment: referring to FIG. 9, in the present embodiment, a preceding proposal block Bₙ₋₁ generated by Validator B in an (n−1)-th consensus round has two certificates, which may be respectively generated by Validator B and Validator D in an (n+1)-th consensus round.

Specifically, in the (n+1)-th consensus round, the validation node Validator B may generate a subsequent proposal block Bₙ₊₁ by referencing proposal blocks Aₙ, Bₙ, and Cₙ generated in an n-th consensus round. Since each of the three proposal blocks Aₙ, Bₙ, and Cₙ references a preceding proposal block Bₙ₋₁ generated in the (n−1)-th consensus round, the subsequent proposal block Bₙ₊₁ may be used as a certificate of the preceding proposal block Bₙ₋₁ for achieving consensus on the preceding proposal block Bₙ₋₁. Meanwhile, in the (n+1)-th consensus round, the validation node Validator D may also generate a subsequent proposal block Dₙ₊₁ by referencing the proposal blocks Aₙ, Bₙ, and Cₙ generated in the n-th consensus round. Since each of the three proposal blocks Aₙ, Bₙ, and Cₙ references the preceding proposal block Bₙ₋₁ generated in the (n−1)-th consensus round, the subsequent proposal block Dₙ₊₁ may be used as a certificate of the preceding proposal block Bₙ₋₁ for achieving consensus on the preceding proposal block Bₙ₋₁.

It should be noted that, in the seventh embodiment, both the subsequent proposal block Dₙ₊₁ generated by the Validator D and the subsequent proposal block Bₙ₊₁ generated by the Validator B may be used as certificates of the preceding proposal block Bₙ₋₁ for achieving consensus on the preceding proposal block Bₙ₋₁.

In the above embodiment, a single preceding proposal block may have multiple subsequent proposal blocks used as certificates thereof, and each of the multiple subsequent proposal blocks used as certificates is generated in the same consensus round. It should be noted that, in some possible embodiments, the multiple subsequent proposal blocks used as certificates may be generated across different consensus rounds, and this case will be explained below by an eighth embodiment.

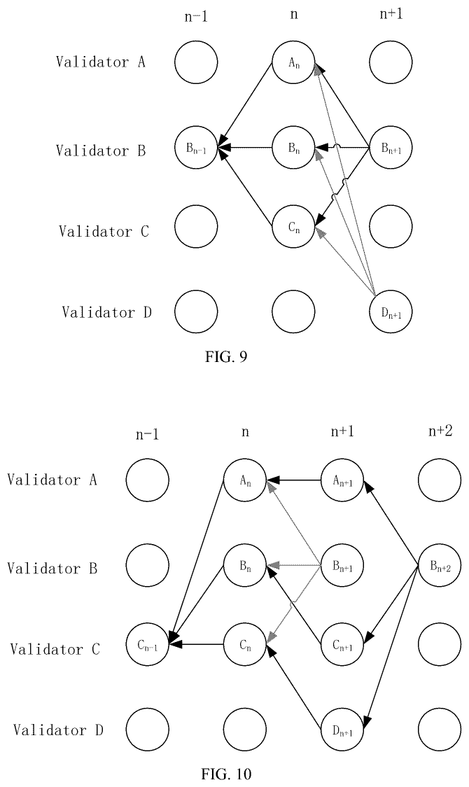

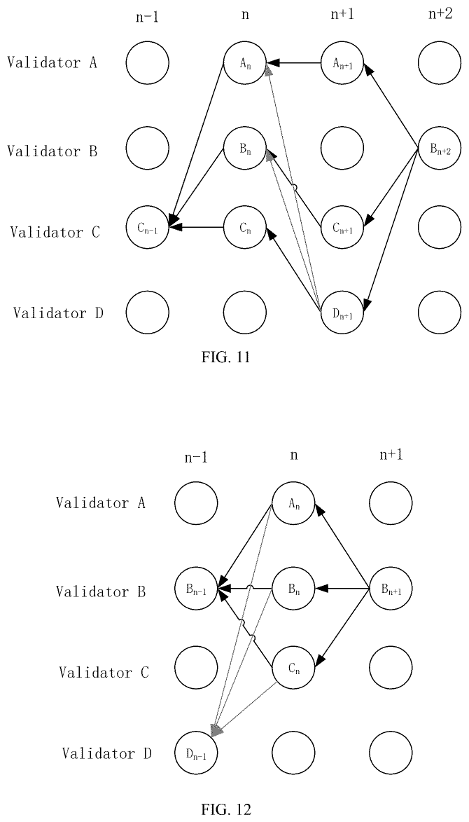

The eighth embodiment: referring to FIG. 10, in the present embodiment, the validation node Validator B may generate a subsequent proposal block Bn+1 in the (n+1)-th consensus round by referencing proposal blocks Aₙ, Bₙ, and Cₙ generated in an n-th consensus round. Since each of the three proposal blocks Aₙ, Bₙ, and Cₙ references a preceding proposal block Cₙ₋₁ generated in an (n−1)-th consensus round, the subsequent proposal block Bₙ₊₁ may be used as a certificate of the preceding proposal block Cₙ₋₁ for achieving consensus on the preceding proposal block Cₙ₋₁.

Meanwhile, the validation node Validator B may generate a subsequent proposal block Bₙ₊₂ in the (n+2)-th consensus round by referencing the proposal blocks Aₙ, Bₙ, and Cₙ generated in the n-th consensus round in an indirect reference manner. Since each of the three proposal blocks Aₙ, Bₙ, and Cₙ references the preceding proposal block Cₙ₋₁ generated in the (n−1)-th consensus round, the subsequent proposal block Bₙ₊₂ may also be used as a certificate of the preceding proposal block Cₙ₋₁ for achieving consensus on the preceding proposal block Cₙ₋₁.

Therefore, in the present embodiment, each of the subsequent proposal block Bₙ₊₁ and the subsequent proposal block Bₙ₊₂ may be used as a certificate for the preceding proposal block Cₙ₋₁, and the subsequent proposal block Bₙ₊₁ and the subsequent proposal block Bₙ₊₂ are generated in different consensus rounds.

In the above eighth embodiment, the two subsequent proposal blocks used as certificates are generated in different rounds, but both are generated by the same validation node represented as Validator B. It should be noted that in some possible embodiments, multiple subsequent proposal blocks used as certificates may also be generated by different validation nodes in different consensus rounds. This will be explained below by a ninth embodiment.

Referring to FIG. 11, in the ninth embodiment, the validation node represented as Validator D may generate a subsequent proposal block Dₙ₊₁ in an (n+1)-th consensus round by referencing proposal blocks Aₙ, Bₙ, and Cₙ generated in an n-th consensus round. Since each of the three proposal blocks Aₙ, Bₙ, and Cₙ references a preceding proposal block Cₙ₋₁ generated in an (n−1)-th consensus round, the subsequent proposal block Dₙ₊₁ may be used as a certificate of the preceding proposal block Cₙ₋₁ for achieving consensus on the preceding proposal block Cₙ₋₁.

Meanwhile, in the (n+2)-th consensus round, the validation node represented as Validator B may generate a subsequent proposal block Bₙ₊₂ in the n-th consensus round by referencing the proposal blocks Aₙ, Bₙ, and Cₙ generated in an indirect referencing manner. Since each of the three proposal blocks Aₙ, Bₙ, and Cₙ references the preceding proposal block Cₙ₋₁ generated in the (n−1)-th consensus round, the subsequent proposal block Bₙ₊₂ may also be used as a certificate of the preceding proposal block Cₙ₋₁ for achieving consensus on the preceding proposal block Cₙ₋₁.

Therefore, in the present embodiment, each of the subsequent proposal block Dₙ₊₁ and the subsequent proposal block Bₙ₊₂ may be used as a certificate for the preceding proposal block Cₙ₋₁, and the subsequent proposal block Dₙ₊₁ and the subsequent proposal block Bₙ₊₂ may be generated by different validation nodes in different consensus rounds.

It should also be noted that in some possible embodiments, the same subsequent proposal block may also be used as a certificate for multiple preceding proposal blocks. This case will be explained by using a tenth embodiment.

Referring to FIG. 12, in the tenth embodiment, the preceding proposal blocks include Bₙ₋₁ and Dₙ₋₁. Based on the reference relationships as shown, the subsequent proposal block Bₙ₊₁ may be used as a certificate for either or both of the preceding proposal block Bₙ₋₁ and the preceding proposal block Dₙ₋₁.

Specifically, the validation node represented as Validator B may generate the subsequent proposal block Bₙ₊₁ in an (n+1)-th consensus round by referencing proposal blocks Aₙ, Bₙ, and Cₙ generated in an n-th consensus round. Since each of the three proposal blocks Aₙ, Bₙ, and Cₙ references the preceding proposal block Dₙ₋₁ generated in an (n−1)-th consensus round, the subsequent proposal block Bₙ₊₁ may be used as a certificate of the preceding proposal block Dₙ₋₁ for achieving consensus on the preceding proposal block Dₙ₋₁. In addition, since each of the proposal blocks Aₙ, Bₙ, and Cₙ references the preceding proposal block Bₙ₋₁ generated in the (n−1)-th consensus round, the subsequent proposal block Bₙ₊₁ may also be used as a certificate of the preceding proposal block Bₙ₋₁ for achieving consensus on the preceding proposal block Bₙ₋₁. Therefore, in the present embodiment, the subsequent proposal block Bₙ₊₁ may be used as a certificate for both the preceding proposal block Bₙ₋₁ and the preceding proposal block Dₙ₋₁.

It should be noted that, when the same subsequent proposal block is used as a plurality of preceding proposal blocks, it is still not limited that the preceding proposal block and the subsequent proposal block must be generated by the same validation node. This case will be explained below by using an eleventh embodiment.

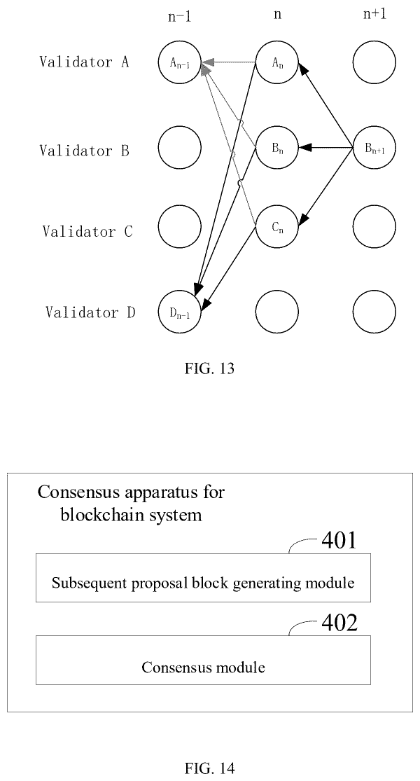

Referring to FIG. 13, the validation node represented as Validator B may generate a subsequent proposal block Bₙ₊₁ in an (n+1)-th consensus round by referencing proposal blocks Aₙ, Bₙ, and Cₙ generated in an n-th consensus round. Since each of the three proposal blocks Aₙ, Bₙ, and Cₙ references a preceding proposal block Dₙ₋₁ generated in an (n−1)-th consensus round, the subsequent proposal block Bₙ₊₁ may be used as a certificate of the preceding proposal block Dₙ₋₁ for achieving consensus on the preceding proposal block Dₙ₋₁. In addition, since each of the proposal blocks Aₙ, Bₙ, and Cₙ references a preceding proposal block Aₙ₋₁ generated in the (n−1)-th consensus round, the subsequent proposal block Bₙ₊₁ may also be used as a certificate of the preceding proposal block Aₙ₋₁ for achieving consensus on the preceding proposal block Aₙ₋₁. Therefore, in the present embodiment, the subsequent proposal block Bₙ₊₁ may be used as a certificate for both the preceding proposal block Aₙ₋₁ and the preceding proposal block Dₙ₋₁.

In a possible implementation, the quantity of proposal blocks is not less than 2f+1, f is the quantity of dishonest validation nodes in the n-th consensus round, and 3f+1 is the total quantity of validation nodes in the n-th consensus round.

It should be noted that using a subsequent proposal block as a certificate for a preceding proposal block needs to satisfy a certain condition. For example, the quantity of proposal blocks referenced by the subsequent proposal block needs to satisfy a condition of 2f+1. This condition may be based on a byzantine fault tolerant algorithm, and the byzantine fault tolerant algorithm is a fault tolerant algorithm oriented to a Byzantine problem, to resolve a problem of how to achieve consensus in a network where communication is reliable but nodes may fail or act maliciously. The core theory is that the total quantity of nodes in the system is greater than or equal to 3f+1, and f is the quantity of allowed faulty nodes. In other words, for a certain proposal block, only a quorum (not less than 2f+1) of validation nodes validating the proposal block can ensure the correctness of the proposal block. Therefore, it may be required for a preceding proposal block that the quantity of proposal blocks generated by the preceding proposal block is not less than 2f+1 in the embodiments of the present disclosure.

In addition, for the examination of the reference relationships, a depth-first search (DFS) manner may be adopted. A certain subsequent proposal block generated in an (n+x₂)-th consensus round may be used as a starting point, and proposal blocks having reference relationships with the subsequent proposal block may be traversed preferentially. In this way, it may be determined whether a specific preceding proposal block is supported by enough validation nodes through the reference relationships.

The DFS is an algorithm used for traversing or searching a tree/graph. In the embodiments of the present disclosure, the traversal may be performed based on a directed acyclic graph. Specifically, when a subsequent proposal block references proposal blocks from previous rounds, the referenced blocks may be tracked and validated in the DFS manner by using the subsequent proposal block as a starting point.

The traversal process will be explained below in combination with the principle of the DFS. A validation node may take a subsequent proposal block generated in an (n+x₂)-th consensus round as a starting point, and then need to select first neighbor nodes. Since the current block references one or more previous blocks, the validation node will first select these referenced blocks as the first neighbor nodes for traversal. Then, for each of the referenced blocks (neighbor nodes), the validation node will examine whether the block in turn references other blocks. If yes, the validation node may recursively continue to traverse these referenced blocks until there are no more referenced blocks. Subsequently, after traversing all blocks of one branch, the validation node may trace back to a previous node and continue to traverse other untraversed neighbor nodes of that node. The traversal process may conclude when all reachable blocks are traversed by the validation node or when a certain preset termination condition (such as traversal depth limitation and time limitation) is satisfied. Thus, it can be determined whether a certain preceding proposal block is supported by enough validation nodes.

Referring to FIG. 14, a consensus apparatus 400 for a blockchain system according to an embodiment of the present disclosure includes a subsequent proposal block generating module 401 and a consensus module 402.

The subsequent proposal block generating module 401 is configured to generate a subsequent proposal block by referencing a plurality of proposal blocks and combining current transactions from clients in an (n+x₂)-th consensus round. The plurality of proposal blocks are correspondingly generated by the plurality of validation nodes referencing a preceding proposal block in an n-th consensus round, and the preceding proposal block is generated in an (n−x₁)-th consensus round.

The consensus module 402 is configured to achieve consensus on the preceding proposal block by using the subsequent proposal block as a certificate for the preceding proposal block.

It should be noted that in the consensus apparatus 400 according to the present disclosure, signature messages in the conventional consensus method are replaced by reference relationships. That is, when a subsequent proposal block references a plurality of proposal blocks, and each of the plurality of proposal blocks references a certain preceding proposal block, the subsequent proposal block is used as a certificate for the preceding proposal block, and the consensus process may be completed according to the certificate. Therefore, when using the consensus apparatus 400 according to the present disclosure to achieve consensus, there is no longer a need to transmit a large amount of signature messages. Instead, it is possible to determine whether a preceding proposal block is validated by a sufficient number of validation nodes through the reference relationships. In this way, the overhead of transmitting and validating signature messages in the consensus process is reduced.

Based on the same inventive concept, in a possible implementation, x₁ and x₂ may be identical or different, and x₁ and x₂ may be each equal to 1 or each not equal to 1.

It should be noted that x₁ may be 1 or a positive integer greater than 1. When x₁ is 1, it indicates that the round in which a proposal block is generated is consecutive to the round in which a preceding proposal block is generated. When x₁ is not 1, it indicates that the round in which a proposal block is generated is not consecutive to the round in which a preceding proposal block is generated. Similarly, x₂ may also be 1 or a positive integer greater than 1. When x₂ is equal to 1, it indicates that the round in which a proposal block is generated is consecutive to the round in which a subsequent proposal block is generated. When x₂ is not equal to 1, it indicates that the round in which a proposal block is generated is not consecutive to the round in which a subsequent proposal block is generated.

Based on the same inventive concept, a validation node may be configured to generate a corresponding proposal block by referring to a preceding proposal block together with other validation nodes.

It should be noted that, in the n-th consensus round, the process of referencing a preceding proposal block to generate a proposal block is involved. An entity executing this process may or may not include the validation node.

Based on the same inventive concept, the subsequent proposal block generation module may be specifically configured to reference a hash index of the any proposal block. The any proposal block may be one of the plurality of proposal blocks or the preceding proposal block.

It should be noted that the proposal block may include a transaction list, a current consensus round, a proposal signer, a proposal signature, and reference relationships with proposal blocks generated in previous rounds. Referring to FIG. 5, each proposal block may include a transaction list (represented as transactions), a current consensus round (represented as round), a proposal signer (represented as author), a proposal signature (represented as signature), and reference relationships (represented as parents) to previous-round proposal blocks.

In a possible implementation, the hash index may be generated based on the current consensus round, the proposal signer, the transaction list, and the reference relationships. Referring to FIG. 5, in the illustrated case, hash indices may include h1, h2, and h3. Here, h1 is calculated by a hash function according to the current consensus round r, the proposal signer v1, the transaction list txs1, and the reference relationship p1; h2 is calculated by a hash function according to the current consensus round r, the proposal signer v2, the transaction list txs2, and the reference relationship p2; and h3 is calculated by a hash function according to the current consensus round r, the proposal signer v3, the transaction list txs3, and the reference relationship p3.

Based on the same inventive concept, the preceding proposal block may be generated by the validation node, or the preceding proposal block may be generated by other validation nodes.

It should be noted that, in the first embodiment, the second embodiment, and the third embodiment, each of the preceding proposal block and the subsequent proposal block may be generated by the same validator. However, in some possible implementations, corresponding to the above three cases, the preceding proposal block and the subsequent proposal block may also be generated by different validators. This will be explained below with specific embodiments.

Based on the same inventive concept, the consensus module is specifically configured for using the subsequent proposal block together with subsequent proposal blocks generated by at least one other validation node independently as certificates for the preceding proposal block. When the quantity of the certificates may be greater than a preset threshold, the preceding proposal block may be validated.

It should be noted that a certificate represents confirmation and acceptance of a to-be-submitted proposal block by a validation node. Each validation node may generate certificates for one or more to-be-submitted proposal blocks. These certificates accumulate to form a quantitative indicator of extent to which one proposal block is accepted. In order to ensure the stability and security of the blockchain, when the quantity of certificates for the proposal block to be submitted reaches or exceeds the preset threshold, the proposal block is considered to have sufficient support and thus submitted to the target blockchain.

It should be further noted that the preset threshold for the quantity of certificates may be adjusted according to a specific circumstance of the blockchain network. For example, when the blockchain network has a relatively small scale or the quantity of validation nodes is relatively small, the preset threshold for the quantity of certificates may be appropriately decreased. Conversely, when the blockchain network has a relatively large scale or the quantity of validation nodes is relatively large, the preset threshold for the quantity of certificates may be appropriately increased.

In the present embodiment of the present disclosure, for a same preceding proposal block, a plurality of subsequent proposal blocks may be used as certificates for the preceding proposal block. The plurality of certificates may be generated by different validation nodes in a same consensus round, or may be generated by a same validation node in different rounds. This will be explained below through specific embodiments.

Based on the same inventive concept, the quantity of proposal blocks is not less than 2f+1, f is the quantity of dishonest validation nodes in the n-th consensus round, and 3f+1 is the total quantity of validation nodes in the n-th consensus round.

It should be noted that using a subsequent proposal block as a certificate for a preceding proposal block needs to satisfy a certain condition. For example, the quantity of proposal blocks referenced by the subsequent proposal block needs to satisfy a condition of 2f+1. This condition may be based on a byzantine fault tolerant algorithm, and the byzantine fault tolerant algorithm is a fault tolerant algorithm oriented to a Byzantine problem, to resolve a problem of how to achieve consensus in a network where communication is reliable but nodes may fail or act maliciously. The core theory is that the total quantity of nodes in the system is greater than or equal to 3f+1, and f is the quantity of allowed faulty nodes. In other words, for a certain proposal block, only a quorum (not less than 2f+1) of validation nodes validating the proposal block can ensure the correctness of the proposal block. Therefore, it may be required for a preceding proposal block that the quantity of proposal blocks generated by the preceding proposal block is not less than 2f+1 in the embodiments of the present disclosure.

In addition, for the examination of the reference relationships, a depth-first search (DFS) manner may be adopted. A certain subsequent proposal block generated in an (n+x₂)-th consensus round may be used as a starting point, and proposal blocks having reference relationships with the subsequent proposal block may be traversed preferentially. In this way, it may be determined whether a specific preceding proposal block is supported by enough validation nodes through the reference relationships.

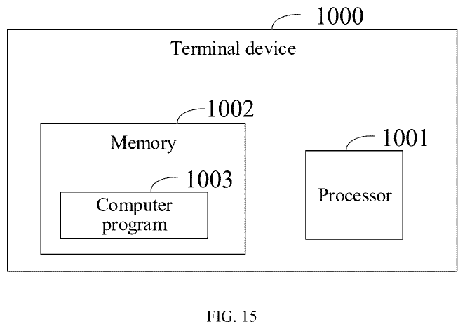

FIG. 15 is a schematic structural diagram of a terminal device according to an embodiment of the present disclosure. The terminal device 1000 includes at least one processor 1001 (only one processor is shown in FIG. 15), a memory 1002, and a computer program 1003 stored in the memory 1002 and executable on the at least one processor 1001. When executing the computer program 1003, the processor 1001 implements the steps in the method of the above embodiments.

The terminal device 1000 may be a computing device such as a desktop computer, a notebook computer, a palmtop computer, and a cloud server. The terminal device may include, but not be limited to, a processor 1001 and a memory 1002. Those skilled in the art may understand that FIG. 15 is merely an example of the terminal device 1000, and does not constitute a limitation on the terminal device 1000. The terminal device may include more or fewer components than those shown in the figure, or some components may be combined, or different components may be included. For example, the terminal device may further include an input/output device, a network access device, and the like.

The processor 1001 may be a central processing unit (CPU). Alternatively, the processor 1001 may be another general-purpose processor, a digital signal processor (DSP), an application-specific integrated circuit (ASIC), a field-programmable gate array (FPGA) or other programmable logic devices, a discrete gate or transistor logic device, a discrete hardware component, or the like. The general-purpose processor may be a microprocessor or the processor may be any conventional processor or the like.

In some embodiments, the memory 1002 may be an internal storage unit of the terminal device 1000, for example, a hard disk drive or an internal storage of the terminal device 1000. In some other embodiments, the memory 1002 may be an external storage device of the terminal device 1000, for example, a removable hard disk, a smart media card (SMC), a secure digital (SD) card, a flash card, or the like that is provided on the terminal device 1000. Furthermore, the memory 1002 may include both the internal storage unit and the external storage device of the terminal device 1000. The memory 1002 is configured to store an operating system, an application program, a boot loader, data, other programs, and the like, for example, program code of the computer program. The memory 1002 may be further configured to temporarily store output data or to-be-output data.

It can be clearly understood by those skilled in the art that, for describing conveniently and concisely, dividing of the above various functional units and functional modules is described exemplarily merely. In an actual application, the above functions can be assigned to different functional units and functional modules to be accomplished. That is, an inner structure of the apparatus is divided into different functional units or modules so as to accomplish the whole or a part of functionalities described above. The various functional units, modules in the embodiments can be integrated into a processing unit, or each of the units exists independently and physically, or two or more than two of the units are integrated into a single unit. The above integrated unit can be either implemented in the form of hardware or in the form of software functional units. In addition, specific names of the various functional units and modules are only used for distinguishing from each other conveniently, but not intended to limit the protection scope of the present disclosure. Regarding a specific operating process of the units and modules in the above system, reference can be made to a corresponding process in the above method embodiments, which is not repeated herein.

An embodiment of the present application further provides a computer-readable storage medium, on which a computer program is stored. When the computer program is executed by a processor, steps in the above method embodiments may be implemented.

Embodiments of the present disclosure provide a computer program product. When the computer program product runs on a mobile terminal, the mobile terminal is enabled to implement the steps in the above method embodiments.

When the integrated unit is implemented in the form of a software functional unit and sold or used as an independent product, the integrated unit may be stored in a computer-readable storage medium. Based on such understanding, all or part of the processes of the method in the above embodiments may be implemented by instructing related hardware by using a computer program, and the computer program may be stored in a computer-readable storage medium. When the computer program is executed by a processor, the steps of the above method embodiments may be implemented. The computer program includes computer program code, which may be in the form of source code, object code, an executable file, some intermediate forms, or the like. The computer-readable medium may include at least any entity or apparatus capable of carrying computer program code to a photographing apparatus/terminal device, a recording medium, a computer memory, a read-only memory (ROM), a random access memory (RAM), an electrical carrier signal, a telecommunication signal, or a software distribution medium, such as a USB flash drive, a mobile hard disk, a magnetic disk or an optical disk. In some jurisdictions, computer-readable media may not include the electrical carrier signal and the telecommunications signal according to legislation and patent practices.

In the above embodiments, the description of each embodiment has its own emphasis. For parts not detailed or described in a certain embodiment, reference may be made to relevant descriptions in other embodiments.

Those skilled in the art will appreciate that the units and algorithm steps of the examples described in connection with the embodiments disclosed herein can be implemented in electronic hardware, or a combination of computer software and electronic hardware. It depends on the specific application and design constraints of the technical solution whether these functions are performed in hardware or software. Professionals may use different methods for each specific application to implement the described functionality, but such implementation should not be considered beyond the scope of the present disclosure.

In the embodiments provided in the present disclosure, it should be understood that the disclosed apparatus/network device and method may be implemented in other ways. For example, the apparatus/network device embodiments described above are merely illustrative. For example, the division of the modules or units is based on logical functionality. In practical implementation, there may be other divisions. For example, multiple units or components may be combined or may be integrated into another system, or some features may be omitted or not executed. Alternatively, the couplings, direct couplings, or communicating connections between the shown or discussed components may be indirect couplings or communicating connections through some interfaces, apparatus, or units, and may be electrical, mechanical, or of other forms.

The units described as separate components may or may not be physically separate. The components displayed as units may or may not be physical units. That is, the components may be located in one place, or may be distributed across multiple network units. Some or all of the units may be selected as required to achieve the objective of the solution in the embodiments.

The above embodiments are merely intended to illustrate the technical solutions of the present disclosure, but are not intended to limit the present disclosure. Although the present disclosure has been described in detail with reference to the above embodiments, those skilled in the art should understand that the technical solutions described in the above embodiments may still be modified, or some technical features may be equivalently replaced. Such modifications or substitutions do not cause the essence of the corresponding technical solutions to depart from the spirit and scope of the technical solutions of the embodiments of the present disclosure and shall fall within the protection scope of the present disclosure.

What is claimed is:

1. A consensus method for a blockchain system, wherein the blockchain system comprises a plurality of validation nodes, the consensus method is executed by a validation node, and the consensus method comprises:
generating a subsequent proposal block by referencing a plurality of proposal blocks and combining current transactions from clients in an (n+x₂)-th consensus round, wherein the plurality of proposal blocks are correspondingly generated by the plurality of validation nodes referencing a preceding proposal block in an n-th consensus round, the preceding proposal block is generated in an (n−x₁)-th consensus round, and x₁ and x₂ are positive integers; and
achieving consensus on the preceding proposal block by using the subsequent proposal block as a certificate for the preceding proposal block.

2. The consensus method of claim 1, wherein x₁ and x₂ are identical or different, and x₁ and x₂ are each equal to 1 or each not equal to 1.

3. The consensus method of claim 1, wherein the corresponding generation of the plurality of proposal blocks by the plurality of validation nodes referencing the preceding proposal block comprises:
correspondingly generating the plurality of proposal blocks by the validation node, together with others of the plurality of validation nodes, referencing the preceding proposal block.

4. The consensus method of claim 1, wherein a step of referencing any proposal block comprises:
referencing a hash index of the any proposal block, wherein the any proposal block is one of the plurality of proposal blocks or the preceding proposal block.

5. The consensus method of claim 1, wherein the preceding proposal block is generated by the validation node, or the preceding proposal block is generated by other validation nodes.

6. The consensus method of claim 1, wherein using the subsequent proposal block as the certificate for the preceding proposal block comprises:
using the subsequent proposal block together with subsequent proposal blocks generated by at least one other validation node independently as certificates for the preceding proposal block, and when the quantity of the certificates is greater than a preset threshold, the preceding proposal block is validated.

7. The consensus method of claim 1, wherein the quantity of the plurality of proposal blocks is not less than 2f+1, where f is the quantity of dishonest validation nodes in the n-th consensus round, and 3f+1 is the total quantity of validation nodes in the n-th consensus round.

8. A consensus apparatus for a blockchain system, comprising:
a subsequent proposal block generating module, configured to generate a subsequent proposal block by referencing a plurality of proposal blocks and combining current transactions from clients in an (n+x₂)-th consensus round, wherein the plurality of proposal blocks are correspondingly generated by the plurality of validation nodes referencing a preceding proposal block in an n-th consensus round, the preceding proposal block is generated in an (n−x₁)-th consensus round, and x₁ and x₂ are positive integers; and
a consensus module, configured to achieve consensus on the preceding proposal block by using the subsequent proposal block as a certificate for the preceding proposal block.

9. The consensus apparatus of claim 8, wherein x₁ and x₂ are identical or different, and x₁ and x₂ are each equal to 1 or each not equal to 1.

10. The consensus apparatus of claim 8, wherein a step of referencing any proposal block comprises:
referencing a hash index of the any proposal block, wherein the any proposal block is one of the plurality of proposal blocks or the preceding proposal block.

11. The consensus apparatus of claim 8, wherein the preceding proposal block is generated by the validation node, or the preceding proposal block is generated by other validation nodes.

12. The consensus apparatus of claim 8, wherein the quantity of the plurality of proposal blocks is not less than 2f+1, where f is the quantity of dishonest validation nodes in the n-th consensus round, and 3f+1 is the total quantity of validation nodes in the n-th consensus round.

13. A terminal device, comprising a memory, a processor, and a computer program stored in the memory and executable on the processor, wherein the terminal device is any one of a plurality of validation nodes included in a blockchain system; and when executing the computer program, the processor implements the following steps:
generating a subsequent proposal block by referencing a plurality of proposal blocks and combining current transactions from clients in an (n+x₂)-th consensus round, wherein the plurality of proposal blocks are correspondingly generated by the plurality of validation nodes referencing a preceding proposal block in an n-th consensus round, the preceding proposal block is generated in an (n−x₁)-th consensus round, and x₁ and x₂ are positive integers; and
achieving consensus on the preceding proposal block by using the subsequent proposal block as a certificate for the preceding proposal block.

14. The terminal device of claim 13, wherein x₁ and x₂ are identical or different, and x₁ and x₂ are each equal to 1 or each not equal to 1.

15. The terminal device of claim 13, wherein the corresponding generation of the plurality of proposal blocks by the plurality of validation nodes referencing the preceding proposal block comprises:
correspondingly generating the plurality of proposal blocks by the validation node, together with others of the plurality of validation nodes, referencing the preceding proposal block.

16. The terminal device of claim 13, wherein a step of referencing any proposal block comprises:
referencing a hash index of the any proposal block, wherein the any proposal block is one of the plurality of proposal blocks or the preceding proposal block.

17. The terminal device of claim 13, wherein the preceding proposal block is generated by the validation node, or the preceding proposal block is generated by other validation nodes.

18. The terminal device of claim 13, wherein using the subsequent proposal block as the certificate for the preceding proposal block comprises:
using the subsequent proposal block together with subsequent proposal blocks generated by at least one other validation node independently as certificates for the preceding proposal block, and when the quantity of the certificates is greater than a preset threshold, the preceding proposal block is validated.

19. The terminal device of claim 13, wherein the quantity of the plurality of proposal blocks is not less than 2f+1, where f is the quantity of dishonest validation nodes in the n-th consensus round, and 3f+1 is the total quantity of validation nodes in the n-th consensus round.

20. A computer-readable storage medium, on which a computer program is stored, wherein the computer program is executed by a processor to implement the steps of the consensus method of claim 1.
